(19) United States
(12) Patent Application Publication
(10) Pub. No.: US 2023/0244449 A1
(43) Pub. Date: Aug. 3, 2023

(54) RANDOM NUMBER GENERATOR

(71) Applicant: IQRYPTO SRL, Mons (BE)

(72) Inventor: Alessandro Michel BRUNETTI, London (GB)

(73) Assignee: IQRYPTO SRL, Mons (BE)

(21) Appl. No.: 17/999,771

(22) PCT Filed: May 25, 2021
(86) PCT No.: PCT/GB2021/051265

§ 371 Date: Nov. 23, 2022

(30) Foreign Application Priority Data
May 28, 2020 (GB) 2008036.2

(51) Int. Cl. G06F 7/58

(52) U.S. Cl. CPC G06F 7/588

(57) ABSTRACT

A device for generating random numbers includes a circuit element having a high leakage current diode arranged to generate a leakage current of at least 2 pA μm⁻². The device also includes a processor connected to the circuit element. The processor is arranged to measure the leakage current and to generate random numbers based on the measured leakage current.

This invention relates to a device for and a method of generating random numbers, in particular to a device for generating random numbers using a high leakage current diode.

Randomisation is crucial in an ever increasing number of fields and technologies, from cryptography to statistical analysis. In cryptography, the generation of random numbers underpins the mechanisms for providing privacy, enabling information to be transmitted securely, e.g. over the internet or other communications networks. However, generating large quantities of random numbers at high speed can be difficult, especially in simpler and smaller devices which lack the processing power to generate random numbers alongside performing other functions. Another problem is ensuring that random numbers are truly random, rather than merely appearing to be. Especially in cryptography, underlying patterns resulting in pseudorandom numbers reduces the security of encrypted communications significantly.

One approach for generating truly random numbers is to measure physical phenomena that are unpredictable and/or not recurrent. Examples of such physical phenomena include raindrops falling on the ground and the arrival of photons at a detector. Various devices have attempted to exploit the random nature of such physical phenomena to generate truly random numbers. However, these devices have a number of limitations. For example, they may be affected by the performance of pre-existing systems in which they are implemented by requiring certain functions of the larger system to be disabled in order to generate random numbers, or the complexity of these devices may result in difficulties in their implementation into pre-existing systems.

An aim of the present invention is to provide an improved random number generator.

When viewed from a first aspect, the present invention provides a device for generating random numbers comprising:
a circuit element comprising a high leakage current diode arranged to generate a leakage current of at least 2 pA μm⁻²; and
a processor connected to the circuit element, arranged to measure the leakage current and to generate random numbers based on the measured leakage current.

When viewed from a second aspect, the present invention provides a method of generating random numbers comprising:
generating a leakage current of at least 2 pA μm⁻² using a high leakage current diode in a circuit element;
measuring the leakage current using a processor connected to the circuit element; and
generating random numbers based on the measured leakage current.

The present invention provides a device which uses the random physical phenomenon of current leakage in a high leakage current diode to generate random numbers, along with a method of generating random numbers. A high leakage current diode comprises a diode with a significant leakage current, in contrast to photodiodes commonly designed to have the lowest possible leakage.

As photodiodes are designed to measure photons, the leakage current produced by such diodes is often referred to as the “dark” current, because it refers to the current the photodiode produces when no light is incident upon the diode. The leakage (dark) current from the high leakage current diode in the device of the present invention produces a current in the circuit element. This current is measured by a processor connected to the circuit element.

The processor uses the measurement of the dark current to generate random numbers, exploiting the random (stochastic) nature of the dark current. Random numbers generated from a random physical phenomenon may be referred to as quantum random numbers.

The current produced by the high leakage diode and measured by the processor is relatively large, compared to a photodiode in an image sensor for which it is desired to keep the leakage current as low as possible. This larger leakage current helps the processor to generate random numbers at a greater rate than would be possible using a photodiode or other low leakage current diode (e.g. owing to the smaller integration time required as a result of the increased charge generated per unit time).

A larger dark current may also result in a more reliable generation of random numbers. The leakage current follows a probability distribution that can be modelled using a Poisson distribution. A particular property of the Poisson distribution is that the variance is equal to the square root of the mean value of the distribution. As a result of this property, a larger dark current produces measured current values having a greater variation, which helps to provide a more reliable (and faster) generation of random numbers.

As a result of the larger dark current produced by the high leakage current diode, in comparison to photodiodes, as well as or instead of generating a large rate of random numbers, the size of the high leakage current diode may be reduced. Therefore, the device may be small compared to an equivalent image sensor incorporating a photodiode, helping to reduce its fabrication cost. Moreover, additional considerations and complex, expensive fabrication processes used to manufacture known photodiodes which are implemented in order to reduce the leakage current may not need to be applied to fabricate the high leakage diode. This may help to reduce the fabrication cost of the device.

Such a device may be particularly suitable for applications in which the device is integrated as part of a larger system having strict dimension limitations (e.g. in a chip, smart watch or mobile phone). This is the particularly the case because the device of the present invention does not need to be exposed to light, as an image sensor needs to be to perform its function, thus allowing it to be concealed in any suitable and desired location within a larger system.

The device may also be suitable for use in Internet of Things (I) applications (e.g. RFID tags), where the both security and cost of components are important considerations.

The device may thus be suitable for both consumer and industrial (e.g. business to business) applications.

The device provided by the present invention may thus be able to be implemented as a dedicated random number generator, allowing the device to be incorporated into pre-existing systems without requiring the use of pre-existing components of such systems. This may avoid or reduce the need to disable certain functions of a larger system in order to generate random numbers, making it possible for a larger system to generate random number alongside performing other functions. This may improve the integration of the device into pre-existing systems, helping it to be used on a large scale in the electronics industry.

The circuit element may have any suitable and desirable arrangement. Alongside the high leakage current diode, the circuit element may have any suitable and desirable components. In a set of embodiments, the circuit element has the layout of a 3T or 4T image sensor circuit, wherein the 3T or 4T image sensor circuit comprises the high leakage current diode, e.g. instead of a photodiode. However, it will be appreciated that the circuit element may have the layout of other sensor circuits including: 1T, 2T, shared floating diffusion, 5T, 6T or HDR sensor circuits.

Preferably, the high leakage current diode is implemented in the same arrangement in the 3T or 4T circuit as a photodiode in known image sensor circuits, e.g. connected to the same terminals and in the same configuration as a photodiode. The components of the (sensor) circuit element may thus include one or more (e.g. all) of: a transistor, a transistor switch, a floating diffusion, a supply voltage and an output.

Implementing a 3T or 4T image sensor circuit where a photodiode has been substituted for the high leakage current diode provides a (sensor) circuit element with a well understood configuration, which may simplify the implementation of the device into larger systems.

The high leakage current diode may be arranged to generate any suitable and desired level of leakage current of at least 2 pA μm⁻². In a set of embodiments, the high leakage current diode is arranged to generate a leakage current of at least 5 pA μm⁻². Preferably, the high leakage diode is arranged to generate a leakage current of at least 10 pA μm⁻². An increased leakage current may enable the generation a larger and more reliable stream of random numbers.

The high leakage current diode may comprise any suitable and desirable diode. In one set of embodiments the high leakage current diode comprises a solid state diode, e.g. a junction diode.

The (e.g. junction) high leakage current diode may be arranged to generate, in use, a high leakage current in any suitable and desired way. Preferably the high leakage current diode is arranged to operate in a reverse bias mode. Thus preferably the circuit element is arranged to apply a reverse bias voltage across the high leakage current diode, to produce the high (reverse) leakage current.

In one set of embodiments the high leakage current diode comprises a semiconductor diode, e.g. a complementary metal oxide semiconductor (CMOS) diode. In one embodiment the high leakage current diode comprises a metal-semiconductor (junction) diode, e.g. a Schottky diode. Using a Schottky diode, e.g. having a relatively high leakage current (e.g. higher than an equivalent p-n junction diode) under a low or reverse bias, may provide a straightforward implementation for the high leakage current diode in the circuit element and thus help to simplify the production of the device.

In a set of embodiments, the high leakage current diode comprises a p-n junction diode. Thus, in these embodiments, the high leakage current diode comprises a negatively doped (n) (e.g. diffusion) region and a positively doped (p) region (e.g. well), preferably arranged on a (e.g. positively doped (p)) substrate. Preferably the p-region (e.g. p-well) at least partially (e.g. fully) surrounds (e.g. encloses) the n-region. It will be appreciated that in one set of embodiments, the p-n junction could be arranged the opposite way round, e.g. a p-region on an n-substrate. In these embodiments the p-n junction may comprise an n-well. Thus it will be appreciated that all the arrangements described herein with regard to p-n regions apply equally to such junctions with the p and n regions reversed.

In one embodiment the high leakage current diode comprises a lateral defect region (e.g. shallow trench isolation), e.g. embedded in the p-region (e.g. p-well) and/or between the n-region and the p-region (e.g. p-well). The lateral defect region (e.g. shallow trench isolation) helps to protect the high leakage diode from nearby circuitry, e.g. in the circuit element.

The p-n junction may be arranged to provide a high leakage current in any suitable and desirable way. In a set of embodiments the physical structure of the p-n junction is arranged to provide a high leakage current. Thus, for example, the relative configuration of the n-region and the p-region (and the STI, when provided) may be arranged to provide a high leakage current.

The physical structure of the p-n junction may be arranged in any suitable and desirable way to provide, in use, the high leakage current. In a set of embodiments, the shape of the p-n junction is arranged to provide a high leakage current. For example, the perimeter of the n-region (and thus, for example, the boundary between the n-region and the p-region) may comprise a plurality of (e.g. greater than four) corners and/or comprise an irregular shape.

This helps to increase the length of the perimeter, and thus increase the ratio of the surface area to the volume of the n-region. In turn, this helps to provide a higher leakage current by increasing the surface area over which charges can diffuse from the n-region, e.g. to the shallow trench isolation. Increasing the length of the perimeter increases the length of interaction between the n-region and a lateral defect region, e.g. the shallow trench isolation. Corners are also intrinsic sources of defectivity (e.g. resulting from manufacturing processes), thus an increased number of corners of the perimeter of the n-region helps to provide a higher leakage current.

In some embodiments, the p-region (e.g. p-well) may be arranged to provide a (e.g. continuous) barrier between the n-region and the lateral defect region (e.g. shallow trench isolation). For example, the lateral defect region may be at least partially contained within (or outside of) the p-region, such that the n-region and the lateral defect region are not in contact with (spaced from) each other (by at least part of the p-region).

However, in a set of embodiments, the lateral defect region (e.g. shallow trench isolation) is in contact with the n-region (the n-diffusion), e.g. along at least part (e.g. all) of the perimeter of the n-region. The contact between the lateral defect region and the n-region helps to increase the lateral injection and diffusion of charges between the n-region and the lateral defect region. This helps to increase the leakage current generated by the high leakage diode. Having the n-region and the lateral defect region in contact along at least part of the perimeter of the n-region (thus, e.g., expanding the n-region into the region the p-region (e.g. p-well) may otherwise occupy) also helps to increase the relative surface area of the n-region, thus helping to increase the capacity of the high leakage diode.

The lateral defect region (that may be in contact with the n-region) may be any suitable and desired isolation structure, e.g. a shallow trench isolation, a deep trench isolation or a local oxidation of silicon (dioxide) (LOCOS). Such isolation structures, which are generally high defectivity regions containing additional (otherwise unwanted) charges, owing to the defects and stresses they introduce. Bringing such regions into contact with the n-region helps to increases the charge diffusion and thus the leakage current.

In a set of embodiments, the composition of (e.g. the n-region and/or the p-region of) the p-n junction is arranged to provide a high leakage current. Any suitable and desirable composition of the p-n junction for providing a high leakage current may be implemented.

In one set of embodiments the p-n junction comprises one or more impurities (e.g. contaminants or defects). The presence of the contaminants or defects may help to increase the leakage current (e.g. for a given bias voltage) that the high leakage diode is able to generate. The contaminants or defects may be introduced to any part of the p-n junction structure. Preferably the contaminants or defects are introduced into or onto the n-region (the diffusion) of the p-n junction. Thus, in a set of embodiments, the n-region of the p-n junction comprises one or more contaminants or defects (e.g. in or on the n-region), e.g. arranged to generate a high leakage current.

In one set of embodiments, the high leakage diode comprises one or more lateral defects, e.g. on the side of the p-n junction. Such defects may comprise one or more (e.g. all) of: (e.g. defects in) a shallow trench isolation, a local oxidation of silicon (dioxide) (LOCOS), trenches and mechanical stress on the (e.g. side of the) (e.g. p-n junction of the) high leakage diode.

In one set of embodiments, the high leakage diode comprises one or more surface defects, e.g. on the top of the p-n junction. Such defects may comprise (or be created by) one or more (e.g. all) of: a Tetraethyl OrthoSilicate (TEOS) layer, chemical-mechanical polishing (CMP) processes, special finishes, vias and light pipes.

Contaminants may be introduced into the (e.g. n-region of the) p-n junction by injection, ion bombarding, doping or radiating the (e.g. n-region of the) p-n junction Any suitable and desired contaminants may be introduced. In a set of embodiments, the contaminants introduced are metallic (e.g. comprising one or more of tungsten, copper, aluminium, gold, platinum, molybdenum, nickel, iron, chromium, zinc, titanium and vanadium). The contaminants introduced may comprise oxygen and/or hydrogen, e.g. to create defectivities and/or holes in the p-n junction. Defects, e.g. damages, may be created by using (e.g. high energy) electromagnetic sources such as gamma rays or X-rays, or using other high energy (e.g. particle (e.g. alpha)) beams.

Contaminants or defects may help to generate a high leakage current by introducing additional charge carriers into the (e.g. n-region of the) p-n junction. For example, the contaminants may introduce additional charges (e.g. electrons or negatively charged ions) into the n-region of the p-n junction, which helps to increase the diffusion of charges (e.g. electrons) from the n-region to the p-region or the shallow trench isolation, thus helping to increase the leakage current.

The implantation depth of the ions in the n-region may be chosen to control the leakage current generated by the high leakage diode. For example, the implantation depth of ions in the n-region may be greater than 50 nm, e.g. greater than 100 nm, e.g. greater than 1 μm. This helps to may create a larger volume of defectivity and therefore help to increase the leakage current.

The implementation depth may vary depending on the process used for implanting the ions. A suitable and desirable implementation depth may also vary depend on the dimension of the high leakage diode, for example.

In one set of embodiments, the underside (e.g. of the n-region) of the p-n junction comprises defects or contaminants, e.g. created using deep implantation. Again, this helps to increase the charge carriers in the p-n junction which helps to increase the leakage current.

The concentration of the one or more contaminants or defects may be used in any suitable and desired way to control the leakage current. In a set of embodiments the (e.g. n-region of the) p-n junction comprises one or more contaminants or defects having a concentration of at least 10⁹ cm⁻³. Such a concentration of the one or more contaminants or defects helps to increase the numbers of additional charges (e.g. electrons or negatively charged ions) introduced, e.g. into the n-region of the p-n junction, which helps to increase the leakage current.

In a set of embodiments, the p-n junction comprises one or more contaminants on the surface of the (e.g. n-region of the) p-n junction, e.g. arranged to generate a high leakage current. The contaminants may be arranged on the surface of the p-n junction in any suitable way. In one embodiment the contaminants are arranged to at least partially (e.g. fully) cover the surface of the (e.g. n-region of the) p-n junction.

In one embodiment the p-n junction comprises a layer of one or more contaminants on the surface of the (e.g. n-region of the) p-n junction. The layer preferably at least partially (e.g. fully) covers the surface of the (e.g. n-region of the) p-n junction.

The layer of one or more contaminants may have any suitable and desirable composition for increasing the high leakage current. For example, the layer of contaminants may comprise an oxide and/or a metal layer. The contaminant layer may help to provide additional charge carriers in the (e.g. n-region of the) p-n junction. This helps to increase the diffusion of charges from the n-region to the p-region or the shallow trench isolation, thus helping to increase the leakage current.

In a set of embodiments the p-n junction comprises a plurality of (e.g. metal) contacts on the surface of the (e.g. n-region of the) p-n junction. Preferably the plurality of contacts project from the surface of the (e.g. n-region of the) p-n junction. Preferably the plurality of contacts are arranged in an (e.g. regular) array across the surface of the (e.g. n-region of the) p-n junction. Thus, in a preferred embodiment the plurality of contacts at least partially cover the surface of the (e.g. n-region of the) p-n junction.

In one set of embodiments the p-n junction comprises a (e.g. metal) layer extending over at least some of (e.g. the distal ends of) the plurality of contacts. Thus preferably the layer connects the (e.g. distal ends of) the plurality of contacts and may thus be suspended over (spaced from) the surface of the (e.g. n-region of the) p-n junction. As before, the layer preferably at least partially (e.g. fully) covers the surface of the (e.g. n-region of the) p-n junction.

The plurality of (e.g. metal) contacts on the surface of the (e.g. n-region of the) p-n junction may instead comprise a single (e.g. large) contact. In a preferred embodiment, the single contact at least partially (e.g. fully) covers the surface of the (e.g. n-region of the) p-n junction.

Covering the surface of the (e.g. n-region of the) p-n junction helps to prevent light being incident upon the high leakage diode, which may interfere with the generation of the leakage (dark) current. It will be appreciated that because the high leakage diode of the present invention is not concerned with light sensitivity, as is the case with a photodiode, the costly structures, e.g. recessed array or backside techniques, that are used when integrating a photodiode into an image sensor array, may not be necessary. This helps to simplify and reduce the cost of the device of the present invention. It may also help to allow an easier routing of connections to the high leakage diode. In embodiments in which the device forms part of a larger system, this may help the integration of the device into the larger system.

In one embodiment the leakage current generated by the high leakage diode may be controlled by controlling the temperature of the high leakage diode. In a set of embodiments, the device comprises a heating (e.g. resistive) element arranged to heat the high leakage diode. This helps to increase the temperature of (e.g. the n-region and/or the p-region of) the p-n junction, which helps to increase the leakage current.

The (e.g. p-n junction of the) high leakage diode may comprise any one (e.g. all) of the features that a photodiode may comprise. For example, the (e.g. p-n junction of the) high leakage diode may comprise a standard (e.g. CMOS) back end of line and array finish. This helps to allow the high leakage diode to be connected in the circuit element.

As appropriate, any of the aforementioned mechanisms for providing a high leakage current may be combined, e.g. to further increase the leakage current. Increasing the leakage current increases the number and/or rate at which random numbers can be generated by the device.

In a set of embodiments, the device comprises a plurality of circuit elements (e.g. pixels). Each circuit element may be arranged as outlined herein, i.e. comprising a high leakage current diode arranged to generate a leakage current of at least 2 pA μm⁻². Preferably each circuit element is connected to the processor, wherein the processor is arranged to measure the leakage current from each circuit element and to generate random numbers based on the measured leakage current (e.g. a stream of random numbers for each circuit element). It will be appreciated that a device having a plurality (e.g. an array or matrix) of circuit elements enables random numbers to be generated at a greater rate, e.g. than can be generated from a single circuit element.

In a device comprising a plurality of circuit elements (e.g. pixels), the plurality of circuit element (e.g. pixels) may be arranged in any suitable and desirable manner. In a set of embodiments, the plurality of circuit elements (e.g. pixels) are arranged in an N×M dimensional matrix, where N and M are (e.g. any suitable and desirable) integers.

The device may comprise any suitable and desired number of circuit elements. In one set of embodiments the device comprises greater than one million pixels. This helps to increase the rate at which random number may be generated.

For example, in a set of embodiments, (e.g. each circuit element of) the device is arranged to generate random numbers (e.g. bits) at a rate of greater than 50 random numbers per second, e.g. greater than 100 random numbers per second, e.g. greater than 200 random numbers per second, e.g. greater than 500 random numbers per second (e.g. assuming a half-saturation time of between 1 ms and 10 ms). For a megapixel array of circuit elements, for example, this may translate into a rate of greater than 50 Mbits per second, e.g. greater than 100 Mbits per second, e.g. greater than 200 Mbits per second, e.g. greater than 500 Mbits per second.

The leakage current may be output (e.g. read out) from the high leakage diode in any suitable and desired way. In one embodiment the charge generated by the high leakage diode is collected by a (e.g. direct) contact, e.g. on top of the p-n junction, or by a transfer gate of the circuit element.

The processor may comprise any suitable and desired processor, e.g. comprising a processing circuit element arranged to measure the leakage current (from the high leakage diode(s) of the one or more circuit elements) and to generate random numbers based on the measured leakage current(s). The processor may comprise a dedicated processor of the device, e.g. that only generates the random numbers. However, in one set of embodiments the processor comprises a processor (e.g. a central processing unit (CPU)) of a larger data processing device.

The processor may be arranged to generate random numbers in any suitable and desired way from the leakage current(s) from the circuit element(s). The processor may be arranged to measure the leakage current(s) directly, for example. However, in an embodiment the processor is arranged to measure a parameter (e.g. a voltage) representative of the (e.g. magnitude) of the leakage current(s).

In one embodiment the (e.g. (each) circuit element of the) device comprises a capacitor arranged to transform the (respective) leakage current into a voltage. For example, a capacitor of the circuit element may be arranged to transform the leakage current into a voltage. This capacitor may be, for example, a floating diffusion of a 4T circuit element or a diffusion (e.g. an n-diffusion) of a p-n junction (e.g. of a 3T circuit element).

Thus preferably the analogue to digital converter (ADC) is arranged to convert the (analogue) voltage from the capacitor into a digital signal (to be used by the processor to generate random numbers). In one embodiment the analogue to digital converter is arranged to output a single bit (0 or 1) for each measurement of the leakage current from the (e.g. each) circuit element. Thus each bit is representative of the leakage current from a single (e.g. p-n junction of a) circuit element.

The ADC and/or the processor may be arranged to generate random numbers in any suitable and desired way. For example, the processor may be arranged to use the output from the ADC to generate a (e.g. each) random number from a string of bits from the ADC. In one embodiment the random numbers are generated according to a technique from the National Institute of Standard and Technology (NIST).

In a set of embodiments, the (e.g. processor of the) device comprises an analogue-to digital-converter (ADC) arranged to convert the leakage current(s) (from the circuit element(s)) from an analogue to a digital signal. Converting the leakage current from an analogue signal (as output by the circuit element) to a digital signal (e.g. for use by the processor) helps the processor to generate random numbers from the digital output from the ADC. The processor may comprise an integrated analogue-to-digital converter, or the analogue-to-digital converter may be a separate component in the device to the processor.

In a set of embodiments, the processor is arranged to perform statistical testing on the generated random numbers. This may act as a check to determine whether the generated random numbers are suitably random and/or not recurrent.

In a set of embodiments, the invention extends to a data processing (e.g. computing) system comprising the random number generating device as described herein. Preferably the random number generator device comprises a module (e.g. processing unit, such as a system on chip) of the data processing device. The data processing system is preferably a handheld and/or portable device, for example a mobile (e.g. smart) phone. Preferably the data processing system is configured to use (operate) the random number generator device to generate random numbers, e.g. for use by the data processing system.

Preferably a processor (e.g. central processing unit (CPU)) of the data processing system is arranged to control the random number generating device, e.g. to request the generation of a random number (or plurality of random numbers). The processor (e.g. CPU) may be arranged to receive the generated random number(s) from the processor of the random number generating device.

Certain embodiments of the present invention will now be described, by way of example only, with reference to the accompanying drawings in which:

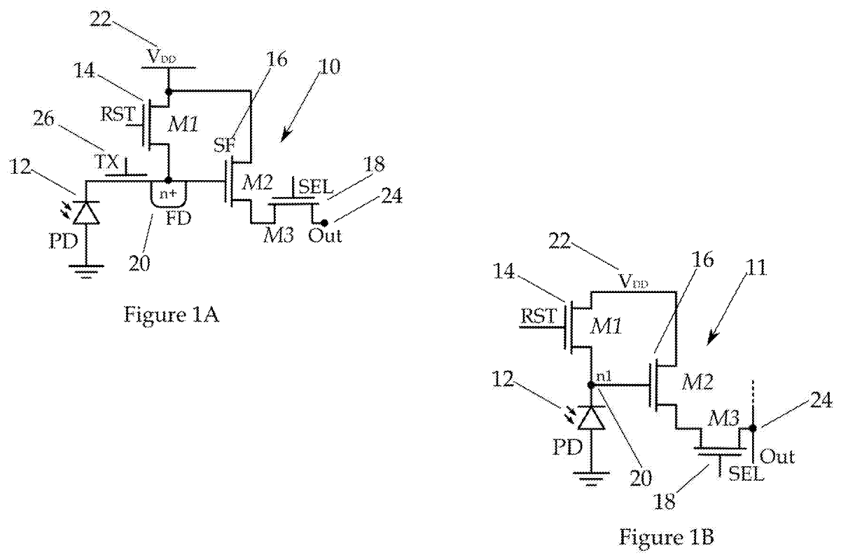

FIGS. 1A and 1B show schematic layouts of 3T and 4T image sensor circuits;

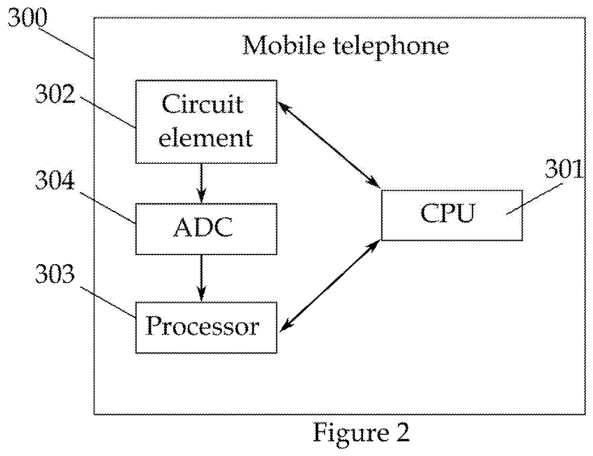

FIG. 2 shows schematically a device in accordance with an embodiment of the present invention;

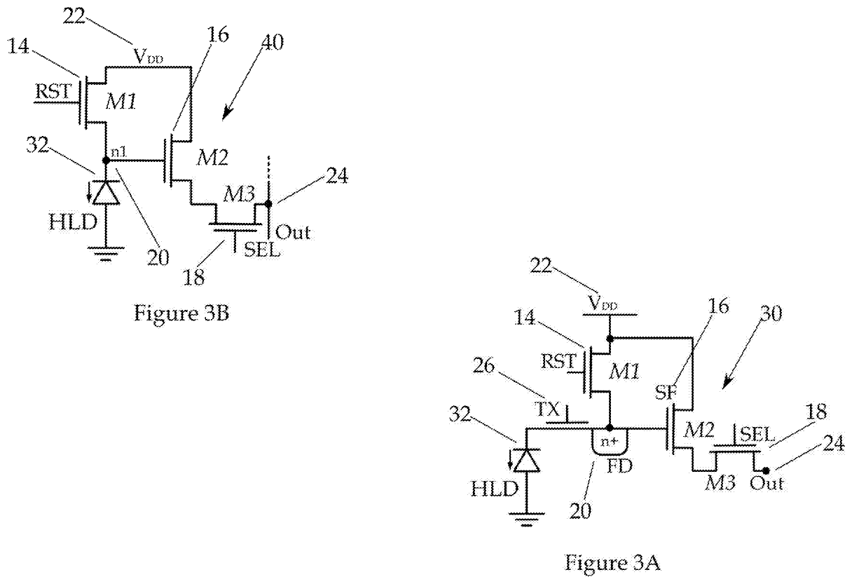

FIGS. 3A and 3B show schematic layouts of a circuit element in accordance with embodiments of the present invention;

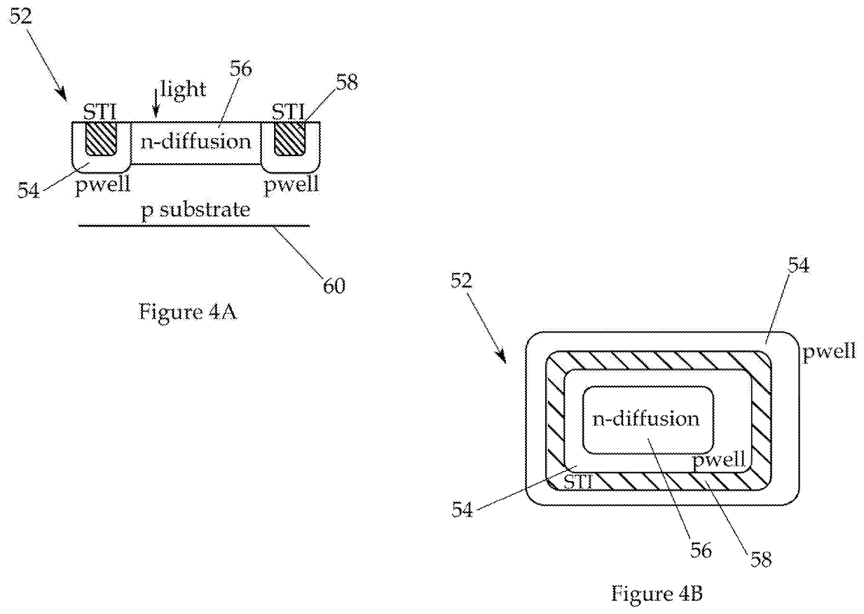

FIGS. 4A and 4B are schematic views of a p-n junction;

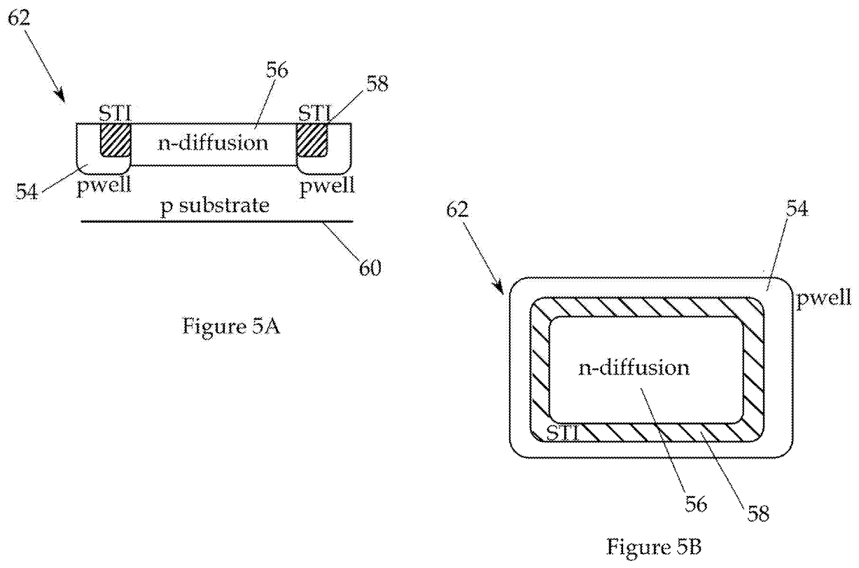

FIGS. 5A and 5B are schematic views of a p-n junction of a high leakage diode in accordance with an embodiment of the present invention

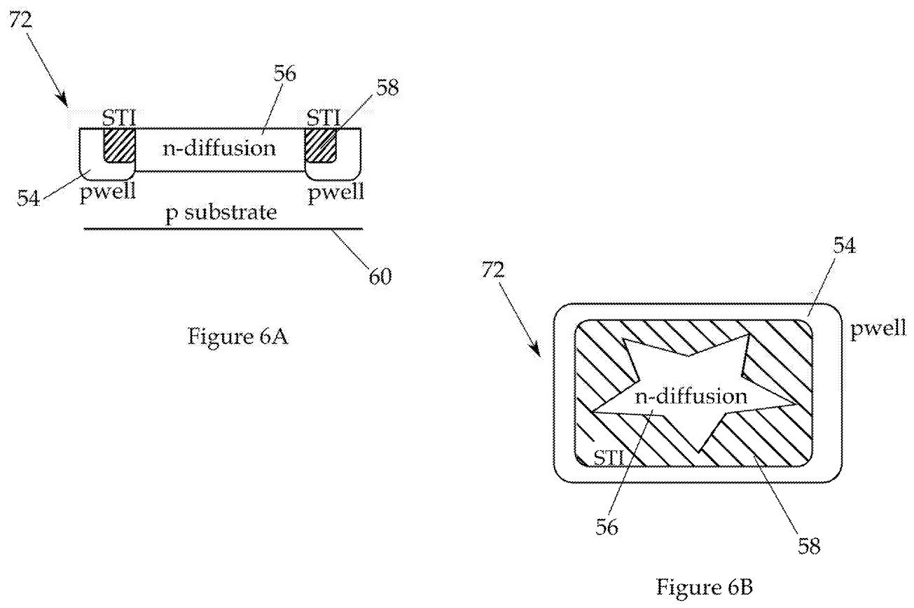

FIGS. 6A and 6B are schematic views of a p-n junction of a high leakage diode in accordance with an embodiment of the present invention;

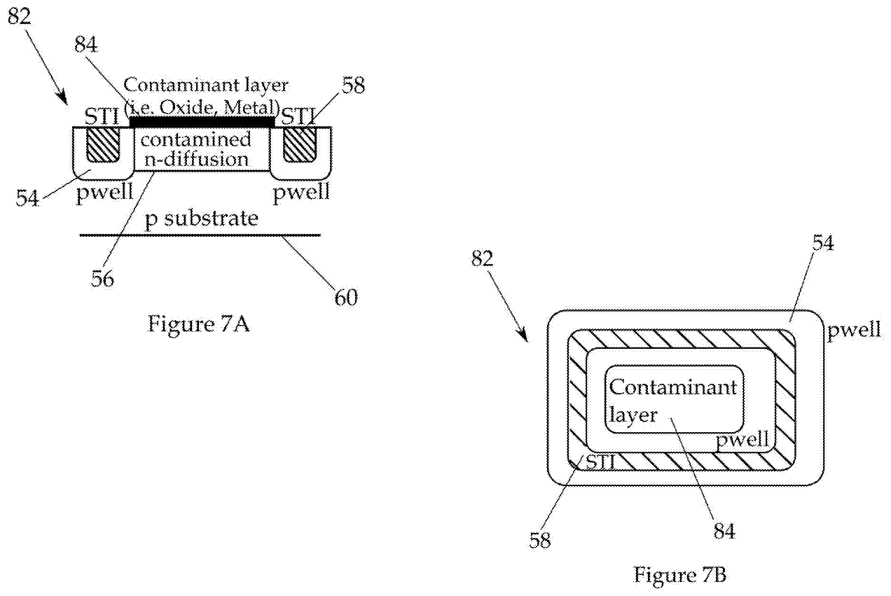

FIGS. 7A and 7B are schematic views of a p-n junction of a high leakage diode in accordance with another embodiment of the present invention;

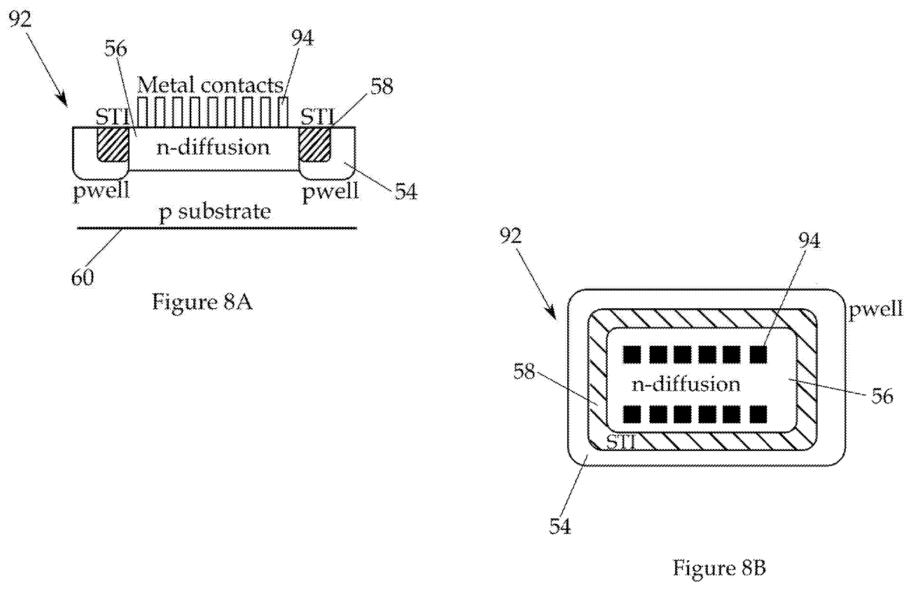

FIGS. 8A and 8B are schematic views of a p-n junction of a high leakage diode in accordance with another embodiment of the present invention;

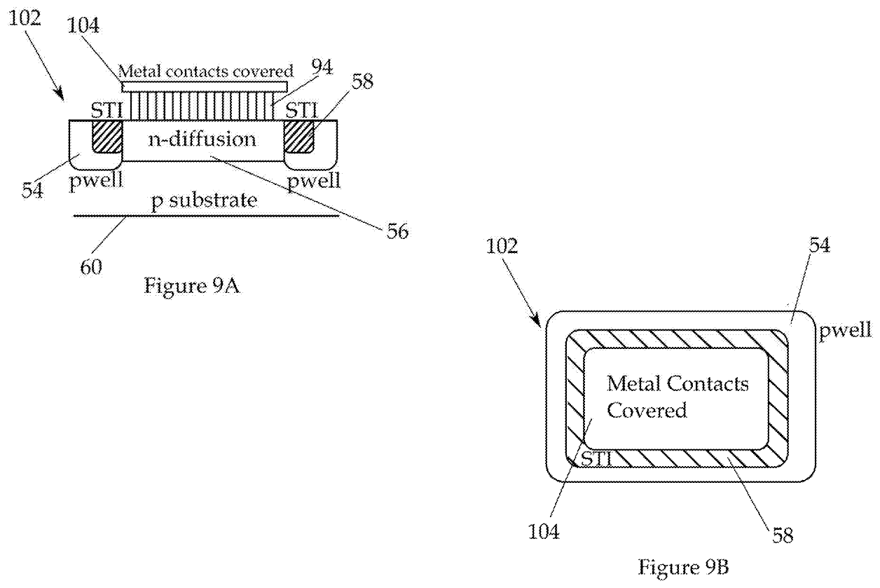

FIGS. 9A and 9B are schematic views of a p-n junction of a high leakage diode in accordance with another embodiment of the present invention;

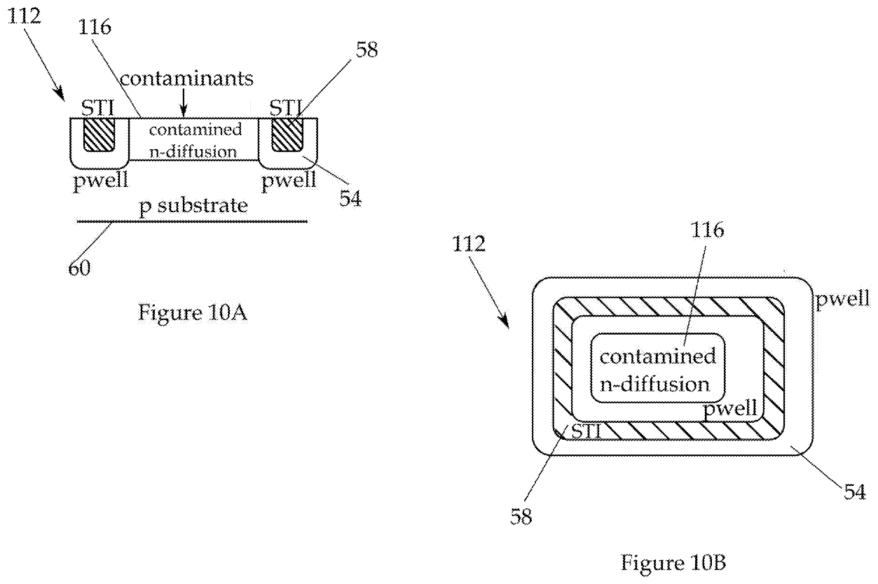

FIGS. 10A and 10B are schematic views is another schematic p-n junction of a high leakage diode in accordance with another embodiment of the present invention;

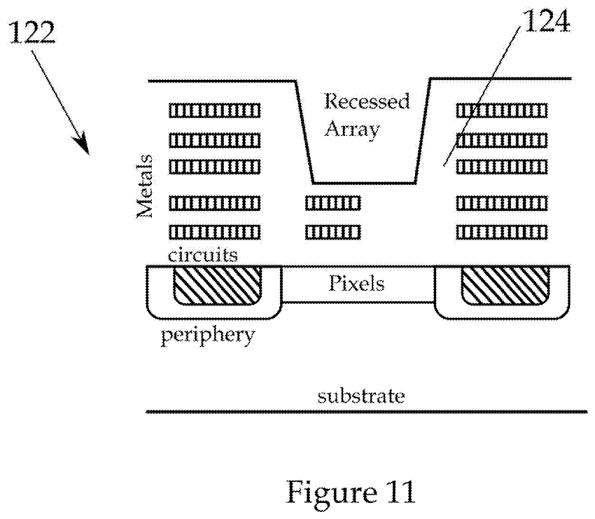

FIG. 11 is a schematic view of a photodiode with a recessed array structure;

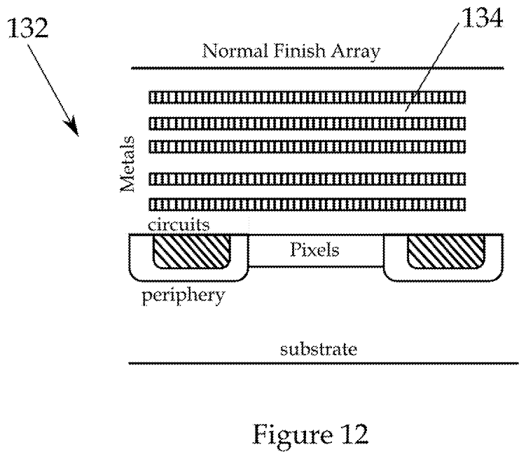

FIG. 12 is a schematic view of a high leakage diode in accordance with an embodiment of the present invention;

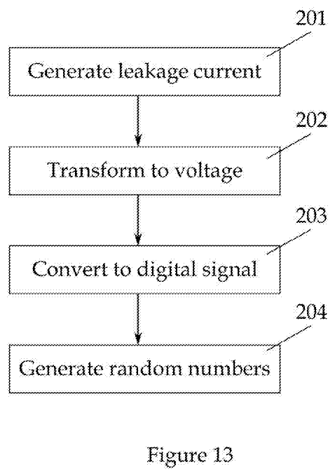

FIG. 13 is flow chart showing the operation of the device in accordance with an embodiment of the present invention; and

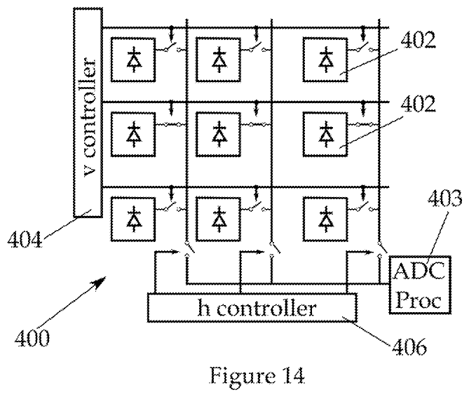

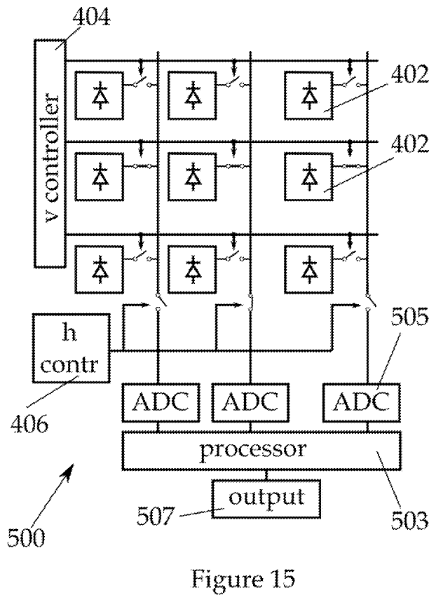

FIGS. 14 and 15 are schematic views of an arrays of circuit elements in accordance with embodiments of the present invention.

Generating truly random numbers is valuable in a number of fields, such as cryptography, the Internet of Things, medical devices, banking, lotteries and statistical analysis. Embodiments of the present invention that provide such a random number generator will now be described.

FIG. 1A shows a circuit diagram for one type of CMOS pixel having four transistors, which is known as a ‘4T’ pixel. FIG. 1B shows a circuit diagram of another type of CMOS pixel having three transistors, which is known as a ‘3T’ pixel. Such CMOS pixels are used for a wide range of applications to detect light for capturing images. In an image sensor, the pixels are organised into arrays of rows and columns. Light is collected by each pixel such that a signal representative of the light incident at each position of the image sensor array may be read-out.

The circuits forming the ‘3T’ and ‘4T’ pixels are referred to as the image sensor circuit 10, 11. Both the ‘4T’ and ‘3T’ pixels include a light sensitive photodiode 12 which occupies a sensitive, ‘active’ area of the pixel. An ‘inactive area’ of the pixels is occupied by the remainder of the image sensor circuit 10 forming the pixel.

Aside from the photodiode 12, the image sensor circuit 11 in the ‘3T’ pixel shown in FIG. 1B comprises a reset transistor (RST) switch 14, a source follower gain (SF) transistor 16, a row-selector transistor (Row Sel) 18, a floating diffusion (FD) 20, a supply voltage (VDD) 22 and an output (Out) 24. In the ‘4T’ pixel shown in FIG. 1A, the image sensor circuit 10 additional includes a transfer gate transistor (TX) 26.

The present invention relates to a device for generating random numbers, where random numbers are generated by measuring the stochastic physical phenomena of a leakage current. FIG. 2 shows schematically a system 300 in accordance with embodiments of the present invention.

The system 300 (e.g. a mobile telephone) includes a CPU 301, a circuit element 302 including a high leakage diode, an analogue to digital converter (ADC) 304 and a processor 303 for generating random numbers. The CPU 301 is connected to the circuit element 302 and to the processor 303, and the circuit element 302 is connected to the processor 303 via the ADC 304. While in FIG. 2 the CPU 301 is shown as connected to the circuit element, there may be other arrangements in which the CPU 301 is not connected to the circuit element, e.g. such that the processor 303 alone controls the circuit element 302. In some embodiments (e.g. in Internet of Things applications) the circuit element 302 is a separate component from the other modules of the system 300, but capable of communicating with the other modules.

When a random number (or sequence of random numbers) is required by (e.g. an application or processing unit of) the mobile telephone 300, the CPU 301 sends a request for the random number(s) to the circuit element 302 or the processor 303. The circuit element 302 operates to generate a high leakage current, which is then converted to a digital signal by the ADC 304 and measured by the processor 303 and used to generate the random number(s). This random number (or sequence of random numbers) is then sent to the CPU 301 for use by the (e.g. application or processing unit of the) mobile telephone 300.

FIGS. 3A and 3B show schematically two possible embodiments of (sensor) circuit elements which may form part of a device (e.g. in the mobile telephone 300 shown in FIG. 2) for generating random numbers in accordance with embodiments of the present invention.

The circuit elements 30, 40 shown in FIGS. 3A and 3B comprise a number of similar components to the image sensor circuits shown in FIGS. 1A and 1B.

Comparing the circuit element 30 as shown in FIG. 3A to the image sensor circuit 10 shown FIG. 1A, the circuits differ in that circuit element 30 comprises a high leakage (e.g. p-n junction) diode 32 instead of the photodiode 12 seen in the image sensor circuit 10.

Similarly, comparing the circuit element 40 as shown in FIG. 3B to the image sensor circuit 11 shown in FIG. 1B, the circuits differ in that the circuit element 40 comprises a high leakage diode 32 instead the photodiode 12 seen in the image sensor circuit 11.

In the circuit elements 30, 40 shown in FIGS. 3A and 3B, a reverse bias is applied across the high leakage diode 32, i.e. the voltage applied across the high leakage diode 32 is in the reserve, low resistance direction of the diode 32. The high leakage diode 32 is therefore said to be ‘reversed biased’. The reverse bias is applied across the circuit element 30, 40 between the supply voltage 22 and an output 24.

The voltage applied across the high leakage diode 32 is relatively low (e.g. compared with the standard forward bias which would typically be applied across a conventional diode) in order to prevent the high leakage diode 32 from breaking down and no longer resisting the flow of current in the reverse direction. Specifically, the voltage does not exceed reserve breakdown voltage inherent to the high leakage diode 32.

When an appropriate reverse bias is applied across the high leakage diode 32 (e.g. below the reserve breakdown voltage of the high leakage diode 32), it may be assumed that there is no conventional current flow due to the high resistance of the high leakage diode 32 in the direction of the reverse bias.

However, due to the increased barrier potential when a reserve bias is applied across the high leakage diode 32, free electrons in a positive (p) region of the high leakage diode flow to the positive terminal of the circuit element 30, 40 and holes in the negative (n) region of the high leakage diode flow to the negative terminal of the circuit element 30, 40. The generated current by the movement of these charges is known as a reverse leakage current. At reverse bias voltages below the breakdown voltage, the current generated by the movement of these charges can be approximated as independent of the reverse bias voltage applied across the high leakage diode 32.

The structure of the high leakage diode in terms of positive (p) and negative (n) regions will now be discussed, in the embodiments when the high leakage diode comprises a p-n junction.

FIGS. 4A and 4B show schematic views of a photodiode 52 suitable for use in a CMOS image sensor pixel. FIG. 4A shows a cross section through the layers of the photodiode 52. FIG. 4B shows a plan view of the photodiode 52 (i.e. in a plane perpendicular to the cross-sectional view of FIG. 4A).

The photodiode 52 may be implemented in the image sensor circuits 10, 11 shown in FIGS. 1A and 1B. The photodiode 52 includes four distinct regions: a p-well 54, a n-region 56 and a shallow trench isolation (STI) 58 that are formed on a p-substrate layer 60 (not seen in the view presented in FIG. 4B). It will be appreciated that the photodiode 52 (and the following embodiments of high leakage diodes) could be formed from different structural elements. For example the n-region 56 could be replaced with a p-region, the p-well 54 replaced with a n-well and the p-substrate layer 60 replaced with an n-type substrate (essentially interchanging positive and negative regions).

The shallow trench isolation 58 in FIGS. 4A and 4B is arranged prevent electric current leakage between the other components of the photodiode 52. In arrangements in which an array of photodiodes 52 are implemented, the shallow trench isolation 58 is arranged to prevent charge leakage from one photodiode 52 to neighbouring photodiodes. The shallow trench isolation may also prevent charge leakage in near-by transistors.

The p-well 54 is formed as a ring with a well extending through the ring. The shallow trench isolation 58 is contained within the well of the p-well 54. The n-region 56 is positioned in the hole of the ring of the p-well 54. This arrangement of the p-well prevents the walls of the shallow trench isolation 58 and n-region 56 from contacting each other, as a section of the p-well 54 extends between the shallow trench isolation 58 and the n-region 56. This helps prevent charges from diffusing between the shallow trench isolation 54 and the n-region 56. The p-well 54 is mounted on the p-substrate layer 60 to provide stability for the photodiode 52 structure.

The photodiode 52 may also include a p+ layer (not shown), which is arranged to reduce the surface defects of the photodiode. By arranging the p+ layer such that it is in contact with the p-well 54, the p+ layer helps to reduce the diffusion of charges between the n-region 56 and the shallow trench isolation 58.

The photodiode 52 shown in FIGS. 4A and 4B is suitable for use in a CMOS pixel in an image sensor as the arrangement of the p-well 54, shallow trench isolation 58 and n-region 56 helps to reduce the diffusion of charge between the shallow trench isolation 54 and the n-region 56. The random diffusion of charges between the shallow trench isolation 54 and the n-region 56 produces an additional current, i.e. a leakage current, to the current produced when a photon is incident on the photodiode. This leakage current is undesirable in applications in which photodiodes are used to detect light to capture images, as it reduces the quality of the image captured due to the obscuring the current generated by the incident photons.

However, in devices according to embodiments of the present invention, the leakage current is harnessed for generating random numbers. Therefore, in the high leakage diode 32 which form part of circuit elements according to embodiments of the present invention shown in FIGS. 3A and 3B, the properties and structure of the diode 32 are selected to obtain a higher leakage current than generated in the photodiode 52 shown in FIGS. 4A and 4B.

FIGS. 5A-10B show a variety of high leakage diodes demonstrating various embodiments of the invention. It will be appreciated by the skilled person that any number of the properties and structures of these high leakage diodes could be combined in order form additional high leakage diode arrangements.

FIGS. 5A and 5B show schematic views of a high leakage diode 62 in accordance with embodiments of the present invention. The high leakage diode 62 comprises the same structural components as the photodiode 52 shown in FIGS. 4A and 4B. However, in the high leakage diode 62 shown in FIGS. 5A and 5B, the shallow trench isolation 58 and the n-region 56 of the high leakage diode are in contact, i.e. the shallow trench isolation 58 is not entirely contain within the p-well 54.

This arrangement of the shallow trench isolation 58, the n-region 56 and the p-well 54 increases the diffusion of charge from the shallow trench isolation 58 into the n-region 56, and therefore results in a high leakage current when a reverse bias is applied across the high leakage diode 62. This is because the shallow trench isolation 58 generates defects and hence charges; with the shallow trench isolation 58 in contact with the n-region 56, the charges diffuse into the n-region 56, generating the leakage current, which is able to be generated in the high leakage diode 62 without any light needing to be incident upon the high leakage diode 62.

FIGS. 6A and 6B show schematic views of a high leakage diode 72 according to another embodiment of the present invention. The high leakage diode 72 comprises the same structural components as the photodiode 52 shown in FIGS. 4A and 4B. Moreover, similarly to the high leakage diode shown in FIGS. 5A and 5B, the shallow trench isolation 58 and the n-region 56 of the high leakage diode 72 shown in FIGS. 6A and 6B are in contact. This provides the same effects as described in relation to FIGS. 5A and 5B. However, in the high leakage diode 72 shown in FIGS. 6A and 6B, the n-region 56 additionally has an irregular shape.

As can be seen clearly from FIG. 6B, the n-region 56 has a ‘star-shaped’ perimeter from viewed from above. The perimeter of the n-region 56 includes ten corners. The irregular shape increases the boundary of the n-region 56 with the shallow trench isolation 58 (i.e. compared with the photodiode 52 shown in FIGS. 4A and 4B), by increasing the length of the perimeter. Increasing the perimeter also increases the ratio of the surface area to volume of the n-region 56.

This arrangement of the n-region 56 increases the diffusion of charge from the n-region 56, and therefore results in a high leakage current when a reverse bias is applied across the high leakage diode 62. As corners are also intrinsic sources of defects (e.g. resulting from manufacturing processes), a large number of corners along the perimeter of the n-region 56 helps to provide a higher leakage current. The leakage current from the high leakage diode 72 shown in FIGS. 6A and 6B thus comes from a different source (i.e. the n-region 56) than the leakage current from the high leakage diode 62 shown in FIGS. 5A and 5B (where contributions to the leakage current come from the shallow trench isolation 58).

Whilst the n-region 56 shown in FIG. 6B is ‘star-shaped’, a skilled person will appreciate that there are a number of different possible arrangements of the boundary of the n-region 56 which may result in a high leakage current.

FIGS. 7A and 7B show schematic views of another high leakage diode 82 according to an embodiment of the present invention. Similarly to the photodiode 52 shown in FIGS. 4A and 4B, the high leakage diode 82 comprises a p-well 54, a n-region 56 and a shallow trench isolation 58. Moreover, as in the photodiode 52 shown in FIGS. 4A and 4B, the shallow trench isolation 58 is contained within the well of the p-well 54. Therefore, the shallow trench isolation 58 and n-region 56 are not in (direct) contact.

However, the high leakage diode 82 additionally comprises a contaminant layer 84. The contaminant layer 84 may be formed from any suitable contaminant, for example an oxide and/or a metal. The contaminant layer 84 completely covers the uppermost (e.g. otherwise exposed) surface of the n-region 56. In the particular embodiment shown in FIGS. 7A and 7B, the contaminant layer 84 extends to cover a portion of the p-well 54 (e.g. the p-well 54 is at least partially covered by the contaminant layer 84).

The contaminant layer 84 introduces contaminants, e.g. additional charge carriers such as electrons or holes, into the n-region 56. For example, a contaminant layer 84 formed from a metal introduces additional electrons (i.e. free electrons from the metal) into the n-region. In another example, a contaminant layer 84 formed from an oxide with also introduce additional electrons into the n-region 56. Increasing the number of electrons in the n-region 56 increases the number of charges diffusing from the n-region, resulting in a high leakage current when a reverse bias is applied across the high leakage diode 82.

Again, the source of the high leakage current in this arrangement differs from those shown previously. Here, the contaminant layer 84 increases the density of the defects within the n-region, which helps to generate the high leakage current.

FIGS. 8A and 8B show a schematic view of a high leakage diode 92 according to an embodiment of the present invention. The structure of the high leakage diode 92 is similar to the high leakage diode 62 shown in FIGS. 5A and 5B. However, the high leakage diode 92 further comprises a number of metal contacts 94 arranged on the upper most (e.g. otherwise exposed) surface of the n-region 56. Unlike the contaminant layer 84 seen in FIGS. 7A and 7B, the contacts 94 only partially cover the n-region 56.

As well as being used to help to increase the leakage current, the contacts 94 may be used to connect the high leakage diode 92 the remainder of the sensor circuit element (e.g. as shown in FIGS. 3A and 3B). The contacts 94 may thus be used to read out the high leakage current from the high leakage diode 92, e.g. through a transfer gate of the circuit element (again, for example, as shown in FIGS. 3A and 3B).

The metal contacts 94 introduce additional electrons (e.g. the free electrons in the metal) into the n-region 56 of the high leakage diode 92. The increased number of electrons in the n-region 56 increases the number of charges diffusing between the shallow trench isolation 58 and the n-region 56, resulting in a high leakage current when a reverse bias is applied across the high leakage diode 82.

FIGS. 9A and 9B show schematic views of a high leakage diode 102 according to an embodiment of the present invention. The structure of the high leakage diode 102 incorporates elements seen in FIGS. 8A and 8B. The high leakage diode 102 additional includes a cover 104 arranged on and supported by the plurality of contacts 94. For example, the cover 104 may be formed from a metal. The inclusion of a metal cover 104 creates a high leakage diode 102 that is similar (in structure and operation) to a Schottky diode.

Unlike a photodiode (e.g. the photodiode 52 shown in FIGS. 4A and 4B), a high leakage diode (for example, the high leakage diode 102 of FIGS. 9A and 9B) does not require at least part of the n-region 56 to be exposed to allow photons to be incident on the n-region 56 as the desired current is the leakage current rather than a photocurrent. Providing a cover 104 may remove some of the noise, caused by photons, from the leakage current generated when a reverse bias is applied across the high leakage diode 102. The cover 104 may also provide additional charge carriers (e.g. electrons) to the n-region 56, and therefore contribute to a high leakage current. Providing a planar cover 104 may also simplify and improve the metallic routing across the high leakage diode 102.

FIGS. 10A and 10B show schematic views of another high leakage diode 112 in accordance with an embodiment of the invention. The high leakage diode 112 has a similar structure to the photodiode 52 shown in FIGS. 4A and 4B, however the composition of the n-region 116 of the high leakage diode 112 differs from that of the n-region 56 of the photodiode 52.

The n-region 116 of the high leakage diode 112 is formed from a semiconductor into which contaminants been introduced during or following the manufacturing of the n-region 116. Contaminants may include ions, which are introduced using techniques such as ion implantation or bombarding. Other techniques which may be used to contaminant the n-region 116 of the high leakage diode 112 with additional charge carriers include exposing the n-region 116 to radiation (e.g. electromagnetic radiation) to ionise atoms which the semiconductor structure of the n-region 116, or to dope the n-region 116 using techniques such diffusion or epitaxy. Defects may also be created using high energy electromagnetic sources such as gamma rays, x-rays or high energy particle beams (e.g. alpha beams).

These techniques increase the numbers of charge carriers in the n-region 116, therefore increase diffusion of charges from the n-region 116, resulting in a high leakage current being produced by the high leakage diode 112.

FIGS. 11 and 12 contrast a photodiode 122 including a recessed front side array 124 and a high leakage diode 132 according to an embodiment of the present invention which also including a front side array 134.

In the photodiode 122 shown in FIG. 11, the front side array 124 is recessed in order to allow photons to reach the n-region 126, which enable the photodiode to act as a photon detector, e.g. in an image sensor array.

In the high leakage diode 132 shown in FIG. 12 does not have a recessed front side array 134 as it is not desirable for photons to be incident on the n-region 136 of the high leakage diode 132. Photons may interfere with the generation or noise associate with the leakage current. The planar, non-recessed metal connections forming the front side array 134 act as a barrier preventing photons from being incident with the n-region 136 of the high leakage diode 132, which may help to reduce the noise in the leakage current generated from the high leakage diode 132. The routing of the metal connections in the front side array 134 is simpler than that required in the recessed front side array 124 seen in FIG. 11, which may simplify and reduce the cost of the high leakage diode.

FIG. 13 is a flow chart demonstrating a method for generating random numbers using a device according an embodiment of the present invention, e.g. the device 300 shown in FIG. 2. The high leakage diode, which may, for example, take the form of any of the photodiodes in FIGS. 5A-10B, generates a leakage current (step 201, FIG. 13) under a reverse bias in a circuit element, e.g. as shown in FIG. 3A or 3B.

The leakage current has a statistical distribution, and in particular a Poisson distribution. The leakage current is inherently stochastic (random). The leakage current is read out using a transfer gate (when using the 4T circuit shown in FIG. 3A) or an ohmic contact on top of the high leakage diode (when using the 3T circuit shown in FIG. 3B). The leakage current is then transformed into a voltage by a capacitor (step 202, FIG. 13). The capacitor may be a diffusion of the 4T circuit shown in FIG. 3A or the n-diffusion of the p-n junction of the 3T circuit shown in FIG. 3B.

The voltage, representative of the leakage current from the high leakage diode, may be pre-processed to remove errors and is then converted by an analogue to digital converter into a digital signal (step 203, FIG. 13). This may be done by comparing the voltage to a mean or median of the distributing (and updating this afterwards), and assigning a 0 for values below the mean (or median) and a 1 for values above (it may help to have an equal probability of obtaining a 0 or a 1). A two bit signal may be generated by comparing the voltage to multiple thresholds, e.g. according to the distribution (such as dividing it into areas of equal probability).

The digital signal is sent to the processor for generating random numbers (step 204, FIG. 13). For an array of circuit elements (pixels) with high leakage diodes that each generate a high leakage current, this results in a stream of digital signals (e.g. bits) being received by the processor.

This string of digital signals may be used to generate random numbers according to a technique from the National Institute of Standard and Technology (NIST) (step 204, FIG. 13).

This process is repeated, e.g. for each integration time of the circuit elements that allows the high leakage diodes to accumulate charge. As the generation of the leakage current is a stochastic process, each circuit element in each time period generating a leakage current is an independent event, and may thus be used to generate truly random numbers.

FIGS. 14 and 15 show schematically examples of arrays of circuit elements 400, 500 in accordance with embodiments of the present invention. The arrays have been shown as 3×3 arrays purely for the purpose of clarity. It will be appreciated, in practice, that such an array may be, and preferably is, (e.g. significantly) larger.

The arrays 400, 500 may have a 4T or 3T arrangement as shown in FIG. 3A or 3B. An array, as shown in FIG. 14 or 15 may, for example, be implemented in the device 300 shown in FIG. 2.

The arrays 400, 500 each include multiple circuit elements (pixels) which each comprise a high leakage diode 402, e.g. as shown in FIGS. 5A to 10B. The arrays 400, 500 additionally include a vertical controller 404 and a horizontal controller 406. The vertical controller 404 and the horizontal controller 406 are arranged to read out signals from each circuit element in the array 400, 500.

The array 400 shown in FIG. 14 comprises a processor 403 that includes an integral analogue-to-digital converter. The vertical controller 404 and the horizontal controller 406 are controlled to read out signals from each of the circuit elements to the processor 403. The processor 403 then provides an output in the form of a random number using, for example, the method described above in relation to FIG. 13.

The array 500 shown in FIG. 15 comprises three separate analogue-to digital converters 505, which provide a digital signal to a processor 503. The array 500 has a column-parallel architecture in which each of the three analogue-to-digital converters 505 receives an input from a respective column of circuit elements. This architecture allows the circuit elements in different columns to be read-out in parallel. The converted digital signal from each of the analogue-to-digital converters 505 is input to the processor 503 and the processor 503 generates a random number based on these inputs, again, for example, using the method described above in relation to FIG. 13. This provides the random numbers to an output 507, e.g. the CPU 301 shown in FIG. 2.

It will be seen from the above that, in at least preferred embodiments of the present invention, a random number generation device is provided in which a high leakage diode is used to generate a high leakage current that is then used to generate (quantum) random numbers. This helps to provide a source of truly random numbers at a usefully high rate.

It will be appreciated that the embodiments shown in the Figures are merely representative examples and that many alternatives are contemplated within the scope of embodiments of the present invention. For example, a Schottky diode (or other diode formed by a semiconductor and a metal, or by a MOS type structure) arranged to generate a high leakage current may be used instead of a p-n junction diode. Furthermore, in the Figures the embodiments shown have a p-substrate with an n-diffusion to form the high leakage diode; it will be appreciated that a similar high leakage diode may be formed from an n-substrate and a p-diffusion.

It will also be appreciated that the leakage current may be generated by a number of different mechanisms and from a number of different sources, e.g. as shown in the Figures. Furthermore, the techniques used to generate the leakage current may be used in any suitable and desired combination of the features described herein.

1.-25. (canceled)

26. A device for generating random numbers comprising:
a circuit element comprising a high leakage current diode arranged to generate a leakage current; and
a processor connected to the circuit element, arranged to measure the leakage current and to generate random numbers based on the measured leakage current.

27. The device as claimed in claim 26, wherein high leakage current diode is not a photodiode or is not a photodiode not receiving incident light.

28. The device as claimed in claim 26, wherein the high leakage current diode is a Schottky diode.

29. The device as claimed in claim 26, wherein the high leakage current diode comprises a p-n junction diode, wherein the p-n-junction diode comprises a first region and a second region that are formed on a substrate, wherein the first region surrounds at least partially the second region, wherein either the first region is a p-region and the second region is a n-region and the substrate is a p-substrate, or the first region is an n-region, the second region is a p-region and the substrate is an n-substrate, the first region is for example a well.

30. The device as claimed in claim 29, wherein the high leakage current diode comprises a lateral defect region embedded in the first region, for example a shallow trench isolation.

31. The device as claimed in claim 30, wherein the lateral defect region is in contact with the diffusion region of the p-n junction.

32. The device as claimed in claim 29, wherein a perimeter of the second region being the boundary between the first region and the second region has a shape with more than four corners.

33. The device as claimed in claim 29, wherein the p-n junction comprises one or more impurities to generate a high leakage current by introducing additional charge carriers into the p-n junction.

34. The device as claimed in claim 33, wherein the p-n junction comprises one or more contaminants on the surface of the p-n junction.

35. The device as claimed in claim 34, wherein the p-n junction comprises a layer of contaminants on the surface of the p-n junction.

36. The device as claimed in claim 33, wherein the p-n junction comprises one or more lateral defects.

37. The device as claimed in claim 33, wherein the p-n junction comprises one or more surface defects.

38. The device as claimed in claim 33, wherein the impurities have a concentration of a least 10⁹ cm⁻³.

39. The device as claimed in claim 29, wherein the p-n junction comprises a plurality of contacts on the surface of the p-n junction.

40. The device as claimed in claim 39, wherein the plurality of contacts project from the surface of the p-n junction.

41. The device as claimed in claim 39, wherein the plurality of contacts are arranged in an array across the surface of the p-n junction.

42. The device as claimed in claim 39, wherein the p-n junction comprises a layer extending over at least some of the plurality of contacts.

43. The device as claimed in claim 26, wherein the device comprises a plurality of circuit elements each comprising a high leakage current diode arranged to generate a leakage current, each connected to the processor, wherein the processor is arranged to measure the leakage current from each circuit element and to generate random numbers based on the measured leakage currents from the plurality of circuit elements.

44. The device as claimed in claim 26, wherein the device is arranged to generate random numbers at a rate of greater than 50 random numbers per second.

45. The device as claimed in claim 26, wherein the high leakage current diode is arranged to generate a leakage current of at least 2 pA μm⁻².

46. A method of generating random numbers comprising:
generating a leakage current using a high leakage current diode in a circuit element;
measuring the leakage current using a processor connected to the circuit element; and
generating random numbers based on the measured leakage current.
